SEQUENCE LISTING (3 sequences)

SEQ ID NO: 1 - protein, 19 aa, Artificial Sequence
  Signature peptide
EVQLQQPGSELVRPGASVK

SEQ ID NO: 2 - protein, 19 aa, Artificial Sequence
  Signal peptide
QRPGQGLEWIGEINPSSGR

SEQ ID NO: 3 - protein, 7 aa, Artificial Sequence
  Signature peptide
ATLTVDK

(19) United States
(12) Patent Application Publication
(10) Pub. No.: US 2012/0264155 A1
(43) Pub. Date: Oct. 18, 2012

(54) Multiplex Quantitation of Individual Recombinant Proteins in a Mixture by Signature Peptides and Mass Spectrometry

(75) Inventors: Torben P. Frandsen, Frederiksberg C (DK); Henrik Naested, Holte (DK); Jette Wagtberg Sen, Taastrup (DK); Pernille Foged Jensen, Taastrup (DK)

(73) Assignee: Symphogen A/S, Kgs. Lyngby (DK)

(21) Appl. No.: 13/501,051

(22) PCT Filed: Oct. 7, 2010
(86) PCT No.: PCT/DK2010/050258

§ 371 Date: Jun. 26, 2012

Related U.S. Application Data
(60) Provisional application No. 61/256,232, filed on Oct. 29, 2009.

(30) Foreign Application Priority Data
Oct. 9, 2009 (DK) PA 2009 01112

(51) Int. Cl. G01N 27/62

(52) U.S. Cl. 435/23

(57) ABSTRACT

The present invention relates to an analytical method for quantitation of selected multiple recombinant proteins in a complex matrix such as recombinant polyclonal antibodies in serum or recombinant polyclonal antibodies expressed in a culture supernatant.

All patent and non-patent references cited in the present application, are hereby incorporated by reference in their entirety.

### FIELD OF INVENTION

The present invention relates to an analytical method for quantitation of selected multiple recombinant proteins in a complex sample such as recombinant polyclonal antibodies in serum or recombinant polyclonal antibodies expressed in a culture supernatant. The method involves high sensitivity quantitation of peptides by mass spectrometry.

BACKGROUND OF INVENTION

There is a need for quantitative assays for recombinant proteins in various complex protein samples, e.g. in human serum or plasma. Conventionally these assays have been implemented as immunoassays such as e.g. ELISA, making use of specific antibodies against target proteins as specificity and detection reagents.

New methods, particularly involving internal standards of peptides or proteins labelled with isotopes, allow mass spectrometry to provide such quantitative peptide and protein assays. Quantitation by mass spectrometry by use of internal reference peptides is well described in the art. However, there remains an issue of the dynamic range and sensitivity of MS assays when applied to very complex mixtures, such as those created by digestion of whole plasma protein to peptides. The problem concerning dynamic range and sensitivity has previously been addressed by development of immunoaffinity set up in combination with MS for quantitative analysis of endogeneous biomarkers [1-5].

The present invention combines affinity purification of recombinant polyclonal proteins such as recombinant polyclonal antibodies from a complex sample such as serum or plasma or from a culture supernatant and quantitation by mass spectrometry by use of internal reference peptides. The present invention provides improvements in sensitivity by implementation of an affinity purification step.

Another issue addressed by the present invention is integrity of the analyte. Conventionally, quantifying a protein based on peptides leaves a possibility for partially degraded protein being quantified in addition to the intact protein. This is especially a problem when quantifying biological pharmaceuticals for generation of e.g. pharmacokinetic profiles. In a preferred embodiment of the present invention an initial protein A purification step is implemented for the quantification of antibody mixtures. As protein A binds the Fc part of immunoglobulins and the following quantification is based on specific marker peptides derived from the CDR regions, it is rendered probable that it is in fact intact antibody which is quantified.

The method according to the present invention allows detection and quantitation of antibodies in serum without the need of specific anti-idiotypic antibodies as in e.g. ELISA. Furthermore, the method disclosed in the present invention is generic. Only suitable signature peptides have to be identified and verified for quantitation by MS. For even more sensitivity it is possible to implement an immunoaffinity step with antibodies raised against the signature peptides. Because the method of the present invention involves detection of unique peptides by mass spectrometry there is no requirement for high specificity, only high affinity, of the anti-signature peptide antibodies.

Another advantage of the method according to the present invention compared to ELISA is that the mass spectrometry analysis results in an enhanced dynamic range.

### SUMMARY OF INVENTION

The present invention relates to a method for characterization of polyclonality and high through put analysis in pharmacokinetics studies.

The invention relates to a method for quantitation of one or more recombinant proteins in a sample comprising the steps of

i) up-concentration of said one or more recombinant proteins by affinity purification to obtain a first fraction

ii) digestion of said first fraction to release one or more specific signature peptides for each of said recombinant proteins into a second fraction

iii) addition of one or more internal reference peptides for each of said signature peptides to said first fraction and/or said second fraction

iv) optionally up-concentration of said signature peptides and said internal reference peptides using a resin coupled with anti-signature peptide antibodies followed by release of said signature peptides and said internal reference peptides to obtain a third fraction and/or optionally up-concentration of said signature peptides and said internal reference peptides using a resin with a chemistry able to fractionate the sample and thereby up-concentrate the peptides of interest

v) quantitation of said signature peptides by mass spectrometric analysis

The method can be used for quantitation of one or more proteins in a sample. In a preferred embodiment, the method is used for quantification of two or more proteins such as recombinant polyclonal antibodies in a sample. The sample can be a serum or plasma sample, a cell culture or bioreactor supernatant or an in-process recombinant polyclonal antibody sample. The method can be used for determination of in vivo clearance of individual antibodies during pharmacokinetic studies. In another embodiment the method is used for characterization of polyclonality in a drug substance of a recombinant polyclonal antibody sample.

In yet another embodiment the present invention relates to use of the method for quantitation of one or more recombinant proteins according to the present invention in connection with manufacturing of recombinant polyclonal antibodies. The quantitation can be performed during upstream and/or downstream processing on a drug product and/or a drug substance.

A key feature of the invention is that it is directed at establishing quantitative assays for specific recombinant proteins selected a priori, rather than at the problem of comparing all of the unknown components of one or more samples to one another. The method according to the present invention can be used for analysis of one or more homologous recombinant proteins in serum samples, wherein said serum sample comprises a background of other homologous proteins.

The method of the present invention can facilitate the analysis of individual antibodies of a polyclonal antibody composition in serum for e.g. pharmacokinetic studies without the need of anti-idiotype antibodies as in e.g. ELISA based techniques. Accordingly, the concentration of recombinant polyclonal antibodies can be determined and/or monitored in an individual in need thereof e.g. over time after administration such as in pharmacokinetics. Purification is in one embodiment done by Protein A or similar Fc binding molecule and subsequent quantitation is performed by measurement of a peptide preferably in one of the variable domains of the antibody. This ensures that the measured analyte is not a degradation product, as it depends on the presence of both Fc and Fab.

### DEFINITION AND ABBREVIATIONS

The term ‘signature peptide(s)’ means one or more different peptide(s) selected as a monitor fragment/peptide of a given protein in a sample.

The term ‘internal reference peptides’ means an isotope labelled peptide with the same amino acid sequence as the signature peptide. ‘Internal reference peptides’ can be any altered version of the respective signature peptide that is 1) recognized as equivalent to the signature peptide by an appropriate binding agent or chemically equivalent by biophysical properties and 2) differs from it in a manner that can be distinguished by a mass spectrometer, either through direct measurement of molecular mass or through mass measurement of fragments (e.g. through MS/MS analysis), or by another equivalent means.

The term ‘antibody’ refers to any of the classes of immunoglobulin molecules of any species, or any molecules derived there from, or any other specific binding agents constructed by variation of a conserved molecular scaffold so as to specifically bind an analyte or monitor fragment such as a recombinant protein and/or signature peptide.

The term ‘anti-peptide antibody’ is used synonymously with ‘anti-signature peptide antibody’ and it may be any type of antibody (in the preceding general sense) that binds a peptide such as a signature peptide and an internal reference peptide for the purposes of enrichment from a sample or processed sample. In general, any use made of an antibody herein is understood to be a purpose that could also be served by another binding agent such as an affibody or an antibody mimic. In one embodiment the binding of the anti-peptide antibody to the peptide does not have be very specific—i.e. high affinity and/or avidity is in one embodiment more important.

The terms ‘binding agent’ may be any of a large number of different molecules, biological cells or aggregates. In this context, a binding agent binds to an analyte being detected in order to enrich it prior to detection, and does so in a specific manner, such that one or more analytes are bound and enriched. Proteins, polypeptides, peptides, nucleic acids (oligonucleotides and polynucleotides), antibodies, ligands, polysaccharides, microorganisms, receptors, antibiotics, test compounds (particularly those produced by combinatorial chemistry) may each be a binding agent.

The term ‘bind’ includes any physical attachment or close association, which may be permanent or temporary. Generally, reversible binding includes aspects of charge interactions, hydrogen bonding, hydrophobic forces, van der Waals forces etc. that facilitate physical attachment between the molecule of interest and the analyte being measured.

The term “protein” refers to any chain of amino acids, regardless of length or post-translational modification. Proteins can exist as monomers or multimers, comprising two or more assembled polypeptide chains, fragments of proteins, polypeptides, oligopeptides, or peptides.

The term “recombinant polyclonal antibody” refers to a carefully selected composition of recombinant antibodies molecules manufactured using recombinant technology. The present invention is in particular directed to characterization of recombinant polyclonal antibody compositions where the antibodies are expressed using cell lines that are normally used for commercial production of recombinant antibodies, for example one of the human or other mammalian cell lines mentioned above. In the context of the present invention, an antibody is considered recombinant if its coding sequence is known, i.e. also if it is expressed from a hybridoma or an immortalized B-cell. In the context of the present invention the term “recombinant protein” includes a “recombinant polyclonal antibody”.

A recombinant polyclonal antibody describes a composition of different antibody molecules which is capable of binding to or reacting with several different specific antigenic determinants on the same or on different antigens. A polyclonal antibody can also be considered to be a “cocktail of monoclonal antibodies”. The variability of a polyclonal antibody is located in the so-called variable regions of the individual antibodies constituting the polyclonal antibody, in particular in the complementarity determining regions CDR1, CDR2 and CDR3 regions. The polyclonal antibodies that may be characterized by the method of the invention may be of any origin, e.g. chimeric, humanized or fully human. The recombinant polyclonal antibody according to the invention preferably comprises a population of at least two different antibodies.

The term “polyclonality” refers to the fact that a recombinant polyclonal protein contains a defined number of proteins and thus is polyclonal in contrast to a conventional recombinant protein or monoclonal antibody. This terminology can be used to describe polyclonality both at the genetic and protein level. The variability of a recombinant polyclonal protein is characterized by differences in the amino acid sequences of individual members of the recombinant polyclonal protein.

The term “compositional variability” refers to the measured variability of individual recombinant proteins or antibodies in term of actual amounts between final batches.

The term “immunoglobulin” is commonly used as a collective designation for the mixture of antibodies found in blood or serum. Hence a serum-derived polyclonal antibody is often termed immunoglobulin or gamma globulin. However, “immunoglobulin” may also be used to designate a mixture of antibodies derived from other sources, e.g. recombinant immunoglobulin. All immunoglobulins independent of their specificity have a common structure with four polypeptide chains: two identical heavy chains, each potentially carrying covalently attached oligosaccharide groups depending on the expression conditions; and two identical typically non-glycosylated light chains. A disulphide bond joins a heavy chain and a light chain together. The heavy chains are also joined to each other by disulphide bonds. All four polypeptide chains contain constant and variable regions found at the carboxyl and amino terminal, respectively.

Immunoglobulins are divided into five major classes according to their heavy chain components: IgG, IgA, IgM, IgD, and IgE. There are two types of light chain, K (kappa) and A (lambda). Individual molecules may contain kappa or lambda, but never both. IgG and IgA are further divided into subclasses that result from minor differences in the amino acid sequence within each class. In humans four IgG subclasses, IgG1, IgG2, IgG3, and IgG4 are found. In mouse four IgG subclasses are also found : IgG1, IgG2a, IgG2b, and IgG3. In humans, there are three IgA subclasses, IgA1, IgA2, and IgA3. Affibody: Affibody molecules are small and robust high affinity protein molecules that can be engineered to bind specifically to a large number of target proteins.

MS is mass spectrometry.

MS/MS is tandem mass spectrometry.

MRM is multi reaction monitoring, or equivalent tecniques, such as e.g. SRM (single/selected reaction monitoring)

A B-cell receptor is a transmembrane receptor protein located on the outer surface of B-cells. The receptor's binding moiety is composed of a membrane-bound antibody that, like all antibodies, has a unique and randomly-determined antigen-binding site.

A T-cell receptor or TCR is a molecule found on the surface of T lymphocytes (or T cells) that is, in general, responsible for recognizing antigens bound to major histocompatibility complex (MHC) molecules. It is a heterodimer consisting of an alpha and beta chain in 95% of T cells, whereas 5% of T cells have TCRs consisting of gamma and delta chains.

### DESCRIPTION OF DRAWINGS

FIG. 1: Standard curve correlating the ratio of the peak areas of A992 signature peptide to AQUA peptides with the concentration of A992 spiked in a pool of blank Cynomolgus monkey plasma. For each sample 1 pmol of the A992 AQUA peptide was added. The ratio at each concentration was determined in triplicates. The data was fitted with a linear regression and the dotted line shows the 95% confidence band for the best-fit linear regression.

FIG. 2: Standard curve correlating the ratio of the peak areas of A1024 signature peptide to AQUA peptides with the concentration of A1024 spiked in a pool of blank Cynomolgus monkey plasma. For each sample 1 pmol of the A1024 AQUA peptide was added. The ratio at each concentration was determined in triplicates. The data was fitted with a linear regression and the dotted line shows the 95% confidence band for the best-fit linear regression.

FIG. 3: Plasma concentration-time curves for A992 and A1024 in a Cynomolgus monkey dosed with 8 mg/kg drug lead. The concentration of A992 and A1024 was determined from 0.5 to 48 hours following administration of the drug lead.

FIG. 4: Standard curves in a range of 0.2 μg/ml-100 μg/ml, in triplicates (one outlier). Linearity curves show the relation between antibody concentration in a spiked serum sample and relative response signature peptide/reference peptide. The two antibodies are measured simultaneously. Top panel represents the standard curve for A992 and the lower panel the standard curve for A1024.

### DETAILED DESCRIPTION OF THE INVENTION

The present invention relates to a method for quantitation of selected multiple recombinant proteins in a complex sample such as recombinant polyclonal antibodies in serum or recombinant polyclonal antibodies expressed in a cell or tissue culture supernatant. The method involves high sensitivity quantitation of peptides by mass spectrometry.

The invention relates to a method for quantitation of one or more recombinant proteins in a sample comprises the steps of:

i) up-concentration of said one or more recombinant proteins by affinity purification to obtain a first fraction

ii) digestion of said first fraction to release one or more specific signature peptides for each of said recombinant proteins into a second fraction. Reduction and/or alkylation of said first fraction can optionally be performed prior to the digestion

iii) addition of one or more internal reference peptides for each of said signature peptides to said first fraction and/or said second fraction

iv) optionally up-concentrate said signature peptides and said internal reference peptides using a resin coupled with anti-signature peptide antibodies followed by release of said signature peptides and said internal reference peptides to obtain a third fraction and/or optionally up-concentration of said signature peptides and said internal reference peptides using a resin with a chemistry able to fractionate the sample and thereby up-concentrate the peptides of interest

v) quantitation of said signature peptides by mass spectrometry analysis

vi) optionally repeat step i) to v) with a corresponding protein preparation of known concentration spiked into the sample to obtain a protein standard curve

vi) the quantitation of said signature peptides obtained in step v) is compared to the protein standard curve obtained in step vi) and quantitation of said one or more recombinant proteins in said sample is obtained. In one embodiment the method results in absolute quantitation of said one or more recombinant proteins in said sample.

In a preferred embodiment, the present invention relates to a method for quantitation of two or more recombinant proteins in a sample comprising the same steps i) to vi) as defined above.

Step ii) and iii) may be reversed if beneficial in a specific applications.

Step i) Regarding Up-concentration of Recombinant Proteins

Step i) above can comprise any method described in the art for up-concentration/enrichment of the one or more recombinant proteins—the enriched fraction is termed the first fraction. In one embodiment the up-concentration/enrichment captures intact proteins such as intact recombinant proteins such as intact recombinant polyclonal antibodies.

The separation by affinity chromatography is based on differences in affinity towards a specific binding molecule. The binding molecule or a plurality of these (these different options are just termed binding molecule in the following), is immobilized on a chromatographic medium and the sample containing the recombinant proteins are applied to the affinity column under conditions that favour interaction between the individual members and the immobilized binding molecule. Proteins showing no affinity towards the immobilized binding molecule are collected in the column flow-through, and proteins showing affinity towards the immobilized binding molecule are subsequently eluted from the column under conditions that counteract binding (e.g. low pH, high salt concentration or high ligand concentration).

The up-concentration/enrichment can be performed by Protein A. Protein A can be immobilized onto a support and used for purification of total IgG from a crude protein mixture such as serum. Protein A binds with high affinity to human IgG1 and IgG2 as well as mouse IgG2a and IgG2b. Protein A binds with moderate affinity to human IgM, IgA and IgE as well as to mouse IgG3 and IgG1. Protein A can also be used for purification of antibodies from other animals, including monkeys. One recombinant form of Protein A is called MabSelect SuRe. In one embodiment affinity chromatography on a matrix consisting of Staphylococcal protein A immobilized to agarose beads is used in step i). Alternatives include Protein A-SEPHAROSE, protein A immobilized to agarose, Protein A coupled to Activated Arginine-agarose, and Protein A coupled to magnetic, latex and agarose beads, polymer beads, polystyren beads and PEG beads.

In addition to Protein A, other immunoglobulin-binding proteins such as immunoglobulin-binding bacterial proteins like e.g. Protein G, Protein A/G and Protein L can be used in step i) above. Each of these immunoglobulin-binding proteins has a different antibody binding profile in terms of the portion of the antibody that is recognized and the species and type of antibodies it will bind. The invention also relates to the use of other immunoglobulin-binding proteins, such as such Streptococcal protein G, rabbit anti-mouse IgG immunoglobulins, anti-human IgG immuoglobulins and anti-monkey IgG immuoglobulins generated in other species.

The present invention also relates to use of other affinity based purification method in step i). These include any target for an antibody, Fc receptors, Con A (Concanavalin A e.g. from Canavalia ensiformis (Jack bean); recognizes glycoproteins), other types of lectin affinity chromatography, antibodies against the variable part of an antibody or antibodies against the constant part of an antibody such as against the FC part. An antibody on magnetic beads can also be used in step i). In another embodiment recycling immunoaffinity is used in step i).

In another embodiment step i) can comprise purification of one or more antibodies by use of a resin and/or column coupled with one or more peptides or the target antigen recognized by one or more of the recombinant proteins such as one or more recombinant polyclonal antibodies. In one embodiment the purification of the one or more proteins can be via an interaction with a bound target antigen.

The initial up-concentration step such as enrichment by protein A in Step i) can be performed in a batch format such as a 96 well format or as part of a multidimensional LC-MS system. Alternatively it can be performed off line batch wise.

Step ii) Regarding Reduction, Alkylation and Digestion

After the initial up-concentration in step i) the first fraction is digested with a selected protease to release one or more specific signature peptides from each protein to be quantitated into a second fraction. In one embodiment the first fraction is reduced and alkylated prior to the digestion. The second fraction comprises signature peptides and other peptides released by the protease. The reduction, alkylation and digestion of said first and/or second fraction can be performed by any method known in the art. Peptides can e.g. be reduced using dithiothreitol (DTT) and subsequently alkylated with e.g. 4-vinylpyridine, Iodo acetamide or iodoacetic acid.

The first fraction, in which one wishes to measure the one or more selected recombinant protein(s), is preferably digested essentially to completion or partially digested if this can be conducted in a reproducible manner, with the appropriate protease such as trypsin to yield peptides (including the selected signature peptide(s)). For a signature peptide whose sequence appears once in the recombinant protein sequence, this digestion should ideally generate the same number of signature peptide molecules as there were recombinant protein molecules in the first fraction.

The digestion can be carried out by first denaturing the protein sample (e.g., with urea or guanidine HCl), reducing the disulfide bonds in the proteins (e.g. with dithiothreitol or mercaptoethanol), alkylating the cysteines (e.g., by addition of iodoacetamide), and finally (after removal or dilution of the denaturant) addition of the selected proteolytic enzyme such as trypsin, followed by incubation to allow digestion. In one preferred embodiment the denaturing does not result in chemical modification of the proteins. The denaturing can be performed by use of one or more detergents that are MS compatible. In one embodiment RapiGest™ SF Surfactant (Waters) is used to enhance enzymatic digestion of the proteins and as a replacement of urea or guanidine HCL as denaturant during reduction and alkylation.

Following incubation, the action of the protease (e.g. trypsin) is terminated, either by addition of a chemical inhibitor (e.g. DFP or PMSF) or by denaturation (through heat or addition of denaturants, or both), by acidification, or removal (if the protease such as trypsin is on a solid support) of the protease such as trypsin. The destruction of the protease activity is important in order to avoid damage to antibodies later by residual proteolytic activity in the sample.

The digestion can be performed by any protease including trypsin, chymotrypsin, Asp-N, Glu-C, Lys-C, lys-N and Arg-C (cf. the specificity of the proteases in the table herein below). More than one protease can be used such as 2, 3, 4, 5, 6, 7, 8, 9, 10 or more than 10 proteases.

In one embodiment the digestion can be performed by chemical degradation.

| Enzyme | Specificity | Optimal pH | Average MW |
|---|---|---|---|
| Trypsin | Carboxyl side of | pH 8.0 | 23.3 kDa |
| | Arg and Lys | | |
| Asp-N | Amine side of | pH 6.0- | 24.5 kDa |
| | Asp and Cys | 8.5 | |
| Glu-C | Carboxyl side of | pH 4.0- | 29.0 kDa |
| | Glu and Asp | 7.8 | |
| Lys-C | Carboxyl side | pH 8.5 | 28.0 kDa |
| | of Lys | | |
| Arg-C | Carboxyl side | pH 7.5- | 26.5 kDa |
| | of Arg | 8.5 | |
| Lys-N | Amine side of Lys | | |
| Chymotrypsin | Cuts next to | | |
| | Hydrophobic Groups | | |

Step iii) Regarding Internal Reference Peptides

An version of the selected signature peptide(s) labelled with stable isotope(s) is synthesised in which the chemical structure is maintained, but one or more atoms are substituted with an isotope such that MS analysis can distinguish the labelled peptide from the normal peptide (containing the natural abundance of each elements isotopes). These isotopically labelled peptides are termed internal reference peptides.

Prior to and/or after reduction, alkylation and digestion internal reference peptides for each of the signature peptides, labelled with stable isotopes are added to said first and/or second fraction for quantitation, allowing subsequent absolute quantitation. Since the labelled peptide is added at a known concentration, the ratio between the amounts of the natural signature peptide and the labelled internal reference peptide detected by the final MS analysis allows the concentration of the signature peptide in the sample mixture to be calculated.

At least three suitable isotopes (¹³C, ¹⁵N, ¹⁸O) are commercially available in suitable highly enriched (>98 atom %) forms. These can be used for generation of ¹³C-labelled, ¹⁵N-labelled, or ¹⁸O-labelled internal reference peptides.

Stable isotope labels can be incorporated by any method described in the art such as ‘post-harvest’, by chemical approaches or in live cells through metabolic incorporation. This isotopic handle facilitates direct quantification from the mass spectra [6] or by MRM. Preferably the stable isotope labelling is performed by chemical synthesis resulting in generation of an internal reference peptide comprising one heavy amino acid.

In a preferred embodiment one amino acid in the internal reference peptide is labelled. Preferably the one labelled amino acid is lysine or arginine, the amino acid to be labelled should appear in a suitable transition fragment ion for MRM quantitation. The internal reference peptide is preferably a well characterized homogenous preparation of peptide.

A measured aliquot of isotopically-labelled internal reference peptide is in one embodiment then added to a measured aliquot of the digested sample peptide mixture in an fixed amount. Following this addition the selected peptide(s) will be present in the sample in two forms (natural signature peptide and isotopically-labelled internal reference peptide). The concentration of the isotopically-labelled version is accurately known based on the amount added and the known aliquot volumes. The aliquot of isotopically-labelled internal reference peptide can alternatively be added prior to digestion of the sample.

In one embodiment one concentration of isotopically-labelled internal reference peptide(s) is selected and a standard curve is generated by analysis of different amounts signature peptide(s)—i.e. the concentration of the isotopically-labelled internal reference peptide is the same in all samples whereas the concentration of the signature peptide(s) is varied in the standard curve, as it is expected to vary in the samples to be analyzed. The concentration of the isotopically-labelled internal reference peptide(s) is preferably in the middle of the expected measured area—i.e. the concentration of the isotopically-labelled internal reference peptide(s) is preferably approximately an average of the lowest and the highest measured concentration of the signature peptide in the different samples.

Step iv) Regarding Up-concentration of Signature and Internal Reference Peptides

The pool of signature peptides and internal reference peptides may subsequently be up-concentrated by use of a resin coupled with anti-signature peptide antibodies raised e.g. in rabbit. The pool of signature peptides are subsequently released (this fraction is termed the third fraction). Alternatively the signature and reference peptides can be upconcentrated by crude fractionation using any of a broad selection of known separation techniques e.g. anion exchange, cation exchange, hydrophobic interaction, reversed phase, hydrophilic interaction, size exclusion and other separation principles. Step iv) is optional.

For the use of anti-signature peptide antibody, the preparation of the anti-signature peptide antibody (whether polyclonal or monoclonal, or any equivalent specific binding agent) is used to capture and thus enrich a specific signature peptide (a specific peptide fragment of a protein to be quantitated in a proteolytic digest of a complex protein sample) and an internal reference peptide (the same chemical structure but including stable isotope labels).

The upconcentration step in step iv) can be performed in 96 well format or as part of a multidimensional LC-MS system. The up-concentration of peptides can be carried out offline, the eluent concentrated and then applied to a C18 capillary column from which it is eluted into the ESI source. Alternatively, the eluent from the up-concentration of peptides can be eluted directly into the ESI source.

The upconcentration can be done by magnetic beads carrying chemistry corresponding to the separation specificity chosen, or coupled to anti-signature peptide antibodies. In another embodiment recycling immunoaffinity—i.e. recycling of the anti-signature peptide antibody resin—can be used.

The present invention also relates to use of peptide-binding agents other than antibodies such as RNA aptamers, peptide aptamers, affibodies etc for enrichment of signature peptides.

The peptide mixture is crudely fractionated using a separation technique compatible with the biophysical properties of the signature peptide(s). The separation includes either binding of a fraction containing the signature peptides and reference peptides, which share the same chemistry, or alternatively the flow-through will contain the signature peptides and reference peptide. In the case of signature and reference peptides maintained on the resin, they will be eluted by eluent suitable for the chosen matrix and chemistry of the peptides.

Alternatively the peptide mixture is exposed to the peptide-specific affinity capture reagent, which preferentially binds the selected peptide but does not distinguish between labelled and unlabelled forms (since isotopic substitutions are not expected to affect antibody binding affinity). The peptide-specific affinity capture can be performed as follows. After a wash step (e.g. with phosphate-buffered saline) the bound peptides are eluted (e.g. with 10% acetic acid, or a mixture of water and acetonitrile), for MS analysis. The affinity support can, if desired, be recycled in preparation for another sample. In the high-throughput assay applications envisioned, it will be advantageous to recycle the immobilized antibody binding hundreds, if not thousands of times.

The enrichment step allows enrichment and concentration of e.g. low abundance peptides, derived e.g. from low abundance proteins in the sample. In one embodiment this enrichment process delivers only the monitor peptide (i.e. signature peptide and internal reference peptides) to the MS, and makes its detection a matter of absolute MS sensitivity, rather than a matter of detecting the monitor peptide against a background of many others, potentially much higher abundance peptides present in the whole sample digest. This approach effectively extends the detection sensitivity and dynamic range of the MS detector in the presence of other high abundance proteins and peptides in the sample and its digest. In a preferred embodiment—e.g. when the MS method comprises MRM or extracted ion chromatograms—the enrichment process does not necessarily results in that only the monitor peptide is delivered to the MS but rather a mixture of peptides (wherein the concentration of the monitor peptide has been increased compared to the concentration of the monitor peptide prior to the enrichment process). In one embodiment the enrichment process results in an increase of the concentration of the monitor peptide of a factor 5 to a factor 100 such as a factor 5-10, for example a factor 10-15, such as a factor 15-20, for example a factor 20-25, such as a factor 25-30, for example a factor 30-35, such as a factor 35-40, for example a factor 40-45, such as a factor 45-50, for example a factor 50-55, such as a factor 55-60, for example a factor 60-65, such as a factor 65-70, for example a factor 70-75, such as a factor 75-80, for example a factor 80-85, such as a factor 85-90, for example a factor 90-95, such as a factor 95-100.

Step v) Regarding Quantitative Mass Spectrometry

Mass spectrometric (MS) analysis is an essential tool for structural characterization of proteins. Mass spectrometric measurements are carried out in the gas phase on ionized analytes. By definition, a mass spectrometer consists of an ion source, a mass analyzer that measures the mass-to-charge ratio (m/z) of the ionized analytes, and a detector that registers the number of ions at each m/z value. Electrospray ionization (ESI) and matrix-assisted laser desorption/ionization (MALDI) are the two techniques most commonly used to volatize and ionize the proteins or peptides for MS analysis. ESI ionizes the analytes out of a solution and is therefore readily coupled to liquid-based (for example chromatographic and electrophoretic) separation tools. MALDI sublimates and ionizes the sample out of a dry, crystalline matrix via laser pulses. MALDI-MS is normally used to analyse relatively simple peptide mixtures, whereas integrated liquid-chromatographic ESI-MS systems (LC-MS) are preferred for the analysis of complex samples. The mass analyzer is central to the technology and its key parameters are sensitivity, resolution, mass accuracy and the ability to generate information-rich ion mass spectra from peptide fragments (MS/MS spectra). There are at least four basic types of mass analyzer. These are the ion trap, time-of-flight (TOF), quadrupole and Fourier transform ion cyclotron (FT-MS) analysers. They are very different in design and performance, each with its own strength and weakness. These analysers can stand alone or, in some cases, be put together in tandem to take advantage of the strengths of each (for more details, see [8-9]). In both MALDI- and ESI-MS, the relationship between the amount of analyte present and the measured signal intensity is complex and incompletely understood. Mass spectrometers are therefore inherently poor quantitative devices. Stable isotope protein labeling methods have been developed in the proteomic area to obtain quantitative MS data. These methods make use of the fact that pairs of chemically identical peptides of different stable isotope composition can be differentiated in a mass spectrometer due to their mass difference, and that the ratio of signal intensities for such peptide pairs accurately indicates the abundance ratio for the two peptides. During ESI-MS peptides are subjected to ion-supression by other analytes co-eluting during a LC-MS run. Thus quantitation is only solid if the reference peptide co-elutes with the signature peptide/analyte and thus is subjected to the same degree of ion suppression. With a reference peptide that is of identical chemical composition and only differing in mass due to incorporation of an isotope, co-elution of reference and signature peptide is ensured. Thus, relative abundance of the corresponding protein in the original samples can be determined by use of a standard curve correlating the signature peptide to internal reference ratio with absolute concentration of signature peptide. Stable isotope tags can be introduced to proteins via i) metabolic labeling, ii) enzymatically, or iii) chemical reactions. Currently, chemical isotope-tagging of proteins or peptides is the most used method (for more details, see [8]). In one embodiment synthetic peptides comprising one well-defined pure heavy amino acid such as e.g. the AQUA peptides from Sigma Aldrich can be used.

The signature peptides in said second or third fraction according to method disclosed in the present invention are quantitated by quantitative mass spectrometry. Upon elution into a suitable mass spectrometer, the signature peptides (sample derived) and reference (isotope labelled) peptides are quantitated, and their measured abundance ratio used to calculate the abundance of the signature peptide, and its parent protein, in the initial sample. One way of doing the actual quantitation is to obtain a full spectrum and then extract the ion current from the peptides to be measured including the reference peptides, and used the derived extracted ion currents as a quantitative measure by integration of the peak. For this technique any electrospray mass spectrometer capable of analyzing peptides can be used. Alternatively and preferable, multiple reaction monitoring (MRM) can be used. This technique typically requires a triple quadrupole or equivalent instrument even though other instruments can perform experiments with MRM-like properties.

In multiple reaction monitoring (MRM) using triple quadrupole (/linear ion trap) instruments the quadrupole 1 (Q1) is set for a distinct precursor mass that enters the collision chamber. In contrast to product ion scanning where all the fragments are scanning through the third quadrupole (Q3), Q3 is set constant for one or more distinct fragment masses. In this manner the transition Q1-Q3 is monitored. The signal is highly specific and is thus used to detect distinct proteins/peptides in a very complex mixture. Moreover its intensity typically is proportional to sample amount over five orders of magnitude. Thus this technique enables a very specific and sensitive multiplex quantitative method over a broad dynamic range. The present invention relates in one embodiment to use of a MS method based on MRM using triple quadrupole instruments or the like.

The general approach involves digesting proteins (e.g. with trypsin) into peptides that can be further fragmented (MS/MS) in a mass spectrometer to generate a sequence-based identification. The approach can e.g. be used with either electrospray ionization (ESI), and can be applied after one or more dimensions of chromatographic fractionation to reduce the complexity of peptides introduced into the mass spectrometer. The mass spectrometry set up can be a single dimensional LC separation combined with mass spectrometry such as LC separation combined with the extremely high resolution of a fourier-transform ion cyclotron resonance (FTICR) MS. An alternative MS set up is a single LC separation ahead of ESI-MS/MS or MALDI-MS/MS. Two chromatographic separations can also be combined with MS such as ESI-MS/MS or MALDI-MS/MS. The second or third fraction can also be separated by reversed phase based LC-MS and quantitated using appropriate MS technique such as e.g. extracted ion chromatograms or multiple reaction monitoring (MRM). Other MS based method can also be used for absolute quantitation such as MALDI-PSD or ion trap based methods.

In one embodiment the selected peptide(s) (including signature peptide(s) and isotopically-labelled internal reference peptides(s)) enriched in the preceding step is delivered into the inlet of a mass spectrometer, preferably by electrospray ionization. In a embodiment, the peptide(s) are introduced directly into the mass spectrometer in the elution buffer (e. g. 10% acetic acid). Preferably the peptide(s) are applied to a reverse phase (e.g. C-18 or equivalent) column and eluted by a gradient (e.g. of acetonitrile/trifluoroacetic acid in water) into an electrospray source of the mass spectrometer (i.e. LC/MS).

The mass spectrometer can be an ion trap, a triple quadrupole, an ESI-TOF, a TOF, a Q-TOF, on Orbitrap type instrument, or any other instrument of suitable mass resolution and sensitivity. Preferably a triple quadrupole based instrument is used.

A ratio is computed between the amounts of the labelled and unlabelled peptides i.e. the signature peptide is compared to internal reference peptide. Since the amount of labelled peptide added is known, the amount of the signature peptide derived from the sample digest can then be calculated from a standard curve.

Step vi) Regarding Generation of a Protein Standard Curve and Quantitation of Proteins

A protein standard curve such as an antibody standard curve (e.g. a recombinant polyclonal antibody standard curve) may be derived from a corresponding protein (antibody/recombinant polyclonal antibody) preparation of known concentration spiked into a blank sample such as a serum sample. Said protein (antibody/recombinant polyclonal antibody) is purified from the spiked sample and analysed using the same procedure as for the real sample—i.e. using steps i) to v) herein above including a fixed amount of reference peptide added to all samples. The standard curve thus relates a relative signal (signature peptide to reference peptide) with a concentration of signature peptide.

Selection of Signature Peptides

A key feature of the invention is that it is directed at establishing quantitative assays for specific recombinant proteins selected a priori, rather than at the problem of comparing all of the unknown components of two or more samples to one another.

Using the known sequence of the recombinant protein, one selects one or more peptide segments within it as ‘signature peptides’. A good signature peptide can be defined by a set of criteria designed to select peptides that can preferably be chemically synthesized with high yield, that can be detected quantitatively in an appropriate mass spectrometer, and that elicit antibodies when used as antigens, although any peptide resulting from cleavage with the desired enzyme is a possible choice. In one embodiment the one or more of the criteria below can be used for selection of the signature peptides:

a) The peptide has a sequence that results from cleavage of the protein with a desired proteolytic enzyme (e.g. trypsin). All the candidate tryptic peptides can be easily computed from the protein sequence by application of generally available software.

b) The peptide preferably should be intermediate hydrophobic, and soluble in conventional solvents used in enzymatic digestion and affinity chromatography, but should by hydrophobic enough to be retained on a C-18 or equivalent column for desalting.

c) The peptide should preferably ionize well by either electrospray (ESI) or another type of ionization. This characteristic can be estimated by software programs or determined experimentally by MS analysis of a digest of the protein in question to see which peptides are detected at highest relative abundance. Another criterion is good transition in MRM if MRM-based analysis is used.

d) If anti-signature peptide antibodies are used the peptide should preferably be immunogenic in the species in which the anti-signature peptide antibody will be raised. Immunogenicity is generally better for peptides that are hydrophilic; that include a bend predicted by secondary structure prediction software; that include no glycosylation sites; and that are 10-20 amino acids such as preferably 10-15 amino acids in length.

e) If the assay is developed for PK the peptide should preferably not share appreciable homology with any other protein of the target organism such as a human target organism (as determined for example by the BLAST sequence comparison program). This characteristic should tend to reduce any interference in the antibody capture step from peptides originating in proteins other than the target. The presence of interfering peptides should also we tested experimentally.

f) The peptide preferably does not contain chemical reactive residues (Tryptophan, Methionine, Cysteine), or chemically unstable sequences (Asp-Gly, N-term Gln, N-term Asn).

g) The peptide is preferably chemical stabile.

h) The peptide preferably does not aggregate and/or does preferably adhere to one or more undesired surfaces during the experiment.

All possible peptides derived from the target protein can easily be evaluated according to these criteria and one or more peptides selected that best balance the requirements of the method.

Preferably the peptides are selected based on experimental data—e.g. from analysis of a peptide map.

Generation of Anti-peptide Antibodies

To immunize an animal for production of anti-peptide antibodies, the peptide is coupled to a carrier protein (e.g. keyhole limpet hemocyanine (KLH); not homologous to a human protein) and used to immunize an animal (such as a rabbit, chicken, goat or sheep) by one of the known protocols that efficiently generate anti-peptide antibodies. For convenience, the peptide used for immunization and antibody purification preferably contains additional c-terminal residues added to the signature peptide sequence (here abbreviated SIGNATURE), e.g.: n-term-SIGNATURE-lys-gly-ser-gly-cys-c-term. The resulting extended signature peptide can be conveniently coupled to carrier KLH that has been previously reacted with a heterobifunctional reagent such that multiple SH-reactive groups are attached to the carrier. In classical immunization with the peptide (now as a hapten on the carrier protein), a polyclonal antiserum will be produced containing antibodies directed to the peptide, to the carrier, and to other non-specific epitopes. Alternatively, there are many methods known in the art for coupling a peptide, with or without any extensions or modifications, to a carrier for antibody production, and any of these may be used.

Likewise there are known methods for producing anti-peptide antibodies by means other than immunizing an animal with the peptide on a carrier. Any of the alternatives can be used provided that a suitable specific reversible binding agent for the signature peptide is produced.

Specific anti-peptide antibodies are then prepared from this antiserum by affinity purification on a column containing tightly-bound peptide. Such a column can be easily prepared by reacting an aliquot of the extended signature peptide with a thiol-reactive solid support such as commercially available thiopropyl Sepharose. Crude antiserum can be applied to this column, which is then washed and finally exposed to 10% acetic acid (or other elution buffer of low pH, high pH, or high chaotrope concentration) to specifically elute antipeptide antibodies. These antibodies are neutralized or separated from the elution buffer (to prevent denaturation), and the column is recycled to physiological conditions for application of more antiserum if needed.

The peptide-specific antibody is finally immobilized on a column, bead or other surface for use as a peptide-specific affinity capture reagent. In the preferred embodiment, the anti-peptide antibody is immobilized on commercially available protein A-derivatized POROS chromatography media (Applied Biosystems) and covalently fixed on this support by covalent crosslinking with dimethyl pimelimidate according to the manufacturer's instructions. The resulting solid phase media can bind the signature peptide specifically from a peptide mixture and, following a wash step, release the monitor peptide under mild elution conditions (e. g. 10% acetic acid). Restoring the column to neutral pH then regenerates the column for use again on another sample, a process that is well known in the art to be repeatable hundreds of times.

The present invention further relates to a resin or column coupled to more than one different anti-signature peptide antibodies such as 2, 3, 4, 5, 6, 7, 8, 9, 10, 11, 12, 13, 14, 15, 16, 17, 18, 19, 20 or more than 20 different anti-signature peptide antibodies.

Recombinant Protein to be Analysed

The present invention relates to an analytical method for quantitation of selected recombinant proteins in a sample. In a preferred embodiment, the present invention relates to an analytical method for quantitation of selected multiple recombinant proteins in a sample—i.e. a complex matrix. The selected multiple recombinant proteins refers in one embodiment to 2 or more selected recombinant proteins such as 3, 4, 5, 6, 7, 8, 9, 10, 11, 12, 13, 14, 15, 16, 17, 18, 19, 20, 21, 22, 23 ,24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, or more than 100 selected recombinant proteins.

The selected multiple recombinant proteins can comprise or consist of polyclonal recombinant antibodies.

The recombinant polyclonal protein of the present invention is in one embodiment intended to cover a protein composition comprising different, but homologous protein molecules, which are naturally variable, meaning that, in preferred embodiments, the library of variant nucleic acids comprises a naturally occurring diversity. Thus, each protein molecule is homologous to the other molecules of the composition, but also contains one or more stretches of variable polypeptide sequence, which is/are characterized by differences in the amino acid sequence between the individual members of the polyclonal protein. The differences in the amino acid sequence(s) that constitute the variable polypeptide sequence might be as little as one amino acid. Preferably the differences in the amino acid sequence constitute more than one amino acid.

Usually, the natural variability of a polyclonal antibody or TcR is considered to be located in the so-called variable regions or V-regions of the polypeptide chains. In one aspect of the present invention individual members in a polyclonal protein comprise variable regions that are approximately between 80 and 120 amino acids long. The variable regions may comprise hyper-variable domains, e.g. complementarity determining regions (CDR).

In naturally occurring TcRs there are four CDRs in each variable region. In naturally occurring antibodies there are three CDRs in the heavy chain and three CDRs in the light chain.

In an additional aspect of the present invention the variable regions of the individual members of a polyclonal protein comprise at least one hyper-variable domain that is between 1 and 26 amino acids long, preferably between 4 and 16 amino acids long. This hyper-variable domain can correspond to a CDR3 region. For antibodies each variable region preferably constitute three hyper-variable domains. These can correspond to CDR1, CDR2 and CDR3. For TcRs each variable region preferably constitutes four hyper-variable domains. These can correspond to CDR1, CDR2, CDR3 and CDR4. The hyper-variable domains may alone constitute the variable sequences within a variable region of a recombinant polyclonal protein of the present invention.

In the context of the present invention, variability in the polypeptide sequence (the polyclonality) can also be understood to describe differences between the individual antibody molecules residing in so-called constant regions or C regions of the antibody polypeptide chains, e.g., as in the case of mixtures of antibodies containing two or more different antibody isotypes, such as the human isotypes IgG1, IgG2, IgG3, IgG4, IgA1, IgA2, IgM, IgD, and IgE, or the murine isotypes IgG1, IgG2a, IgG2b, IgG3, IgM, and IgA. Thus, a recombinant polyclonal antibody may comprise antibody molecules that are characterized by sequence differences between the individual antibody molecules in the variable region (V region) or in the constant region (C region) or both. Preferably, the antibodies are of the same isotype, as this eases the subsequent purification considerably. It is also conceivable to combine antibodies of e.g. isotype IgG1, IgG2, and IgG4, as these can all be purified together using Protein A affinity chromatography. In a preferred embodiment, all antibodies constituting the polyclonal antibody have the same constant region to further facilitate purification. More preferably, the antibodies have the same constant region of the heavy chain. The constant region of the light chain may also be the same across distinct antibodies. In another embodiment there can be variability in the constant region.

A composition of a recombinant polyclonal protein of interest comprises a defined subset of proteins, which have been defined by a common feature such as the shared binding activity towards a desired target, e.g., in the case of polyclonal antibodies against the desired target antigen. Typically a polyclonal protein composition has at least 2, 3, 4, 5, 10, 20, 50 or 100 distinct variant members, such from 2 to 5, 2 to 8 or 2 to 10 distinct members. The number of distinct members needed in the recombinant polyclonal protein composition may depend on the complexity of the target. In the case of antibodies the complexity of the antigen(s) targeted will influence the number of distinct variant members necessary in the recombinant polyclonal antibody composition. With small or not very complex targets, for example a small protein, a polyclonal antibody composition that comprises between 2 or 3 and 100 distinct variant members may be sufficient, and it is preferred that the number of variants does not exceed 90, or even 80 or 70. In many instances, the number of distinct variants will not exceed 60 or 50, and it is preferred that the number of variants are in the range between 2 and 40, such as between 2 and 30.

In mammals, there are several known examples of naturally occurring polyclonal proteins either circulating freely in the blood such as antibodies or immunoglobulin molecules or present on cell surfaces such as T cell receptors and B cell receptors. The diversity of these naturally occurring polyclonal proteins are, in some mammals, achieved by genetic recombination of genes encoding variable regions of these proteins. Antibodies are further known to increase their diversity by somatic mutation. For proteins encoded from two independent gene segments, e.g. antibody variable heavy chain and variable light chain, TcRa chain and β chain or TcRδ chain and y chain, each vector in the library will constitute a pair of these variable region encoding sequences.

Diversities of proteins can also be made in an artificial way, for example synthetic or by mutation. Mutations can either be random or point mutations of a nucleic acid sequence encoding a single protein, thereby generating a polyclonal population of the single protein. In a preferred embodiment of the invention, the recombinant polyclonal protein is a recombinant polyclonal antibody or antibody fragment. In another preferred embodiment of the invention, the recombinant polyclonal protein is a recombinant polyclonal TcR or TcR fragment.

A recombinant polyclonal protein of the present invention can therefore also be constituted of the different isotypes or more preferred of different subclasses. Polyclonality of the immunoglobulins can occur in the constant part or in the variable domain of the immunoglobulin molecule or in both the constant part and the variable domain.

Polyclonality in the so-called constant region, particularly the heavy chain of the antibodies, is of interest with regard to therapeutic application of antibodies. The various immunoglobulin isotypes have different biological functions, which might be desirable to combine when utilizing antibodies for treatment because different isotypes of immunoglobulin may be implicated in different aspects of natural immune responses.

The one or more internal reference peptide used in step iii) can be any peptide with a sequence identical to a sequence within a recombinant protein such as a recombinant polyclonal antibody and/or TcR. The internal reference peptide can have the same sequence as a sequence within any region of said recombinant polyclonal antibody such as within the constant region, the variable region, the light chain, the heavy chain, the frameworks, hyper-variable domains, complementary determining regions (CDR) such as CDR1, CDR2 and CDR3. The internal reference peptides can be any combination of internal reference peptides from these different regions.

The one or more internal reference peptide used in step iii) can be any peptide with a sequence identical to a sequence within a recombinant protein such as a recombinant polyclonal antibody for the treatment and/or prophylaxis of a human disease. Recombinant polyclonal antibodies hold promise for a range of therapeutic applications—i.e. related to replacement of plasma-derived immunoglobulins, prevention or treatment of infectious disease, and treatment of cancer. In one embodiment the recombinant protein to be analysed can be one or more of the following:

a) a recombinant polyclonal antibody used for treatment and/or prophylaxis of one or more infectious disease(s)

b) a recombinant polyclonal antibody used for treatment and/or prophylaxis of one or more bacterial infection(s)

c) a recombinant polyclonal antibody used for treatment and/or prophylaxis of one or more viral infection(s)

d) a recombinant polyclonal antibody used for treatment and/or prophylaxis of one or more cancer form(s)

e) a recombinant polyclonal antibody used for treatment and/or prophylaxis of one or more amyloid related disease e.g. Alzheimer's disease.

f) Sym001—a recombinant polyclonal antibody consisting of 25 different recombinant polyclonal anti-Rhesus D (RhD) antibodies (WO 2006/007850).

g) Sym002 composed of recombinant polyclonal anti-vaccinia virus antibodies to place existing anti-vaccinia hyperimmune immunoglobulins (VIG) (WO 2007/065433).

h) Sym003—a recombinant polyclonal product candidate targeting anti-respiratory syncytial virus (RSV) (WO 2008/106980, and WO 2007/101441).

i) Sym004 is a recombinant polyclonal antibody product candidate targeting epidermal growth factor receptor, a human cancer antigen (WO 2008/104183).

j) a recombinant polyclonal antibody product candidate targeting a human cancer antigen.

j) a recombinant polyclonal antibody being developed against a bacterial pathogen.

k) a recombinant polyclonal antibody targeting an infectious disease target.

The method according to the present invention further relates to quantitation of one or more recombinant proteins in a sample comprising one or more different antibodies such as antibodies against snake toxins.

Sample to be Analysed

The sample to be analysed by the method according to the present invention can be any sample comprising one or more recombinant proteins. In one embodiment the sample is serum or plasma—such as human serum or plasma—comprising one or more recombinant proteins such as one or more recombinant polyclonal antibodies. The invention can be used both for analysis of samples from a single individual source or, for purposes of evaluating the level of a particular protein in a population, can be used to analyze pooled samples from the target population.

Another aspect of the present invention is quantitative analysis of one or more reference recombinant protein expressed in a cell culture supernatant or bioreactor. In a preferred embodiment the invention relates to quantitation of one or more recombinant antibodies such as one or more recombinant polyclonal antibodies expressed in a cell culture supernatant or cell culture bioreactor.

The polyclonal protein can for example be derived from a cell culture supernatant obtained from a polyclonal cell culture supernatant. The polyclonal protein can be purified or enriched from the supernatant e.g. by protein A affinity purification, immunoprecipitation or gel filtration. These pre-purification steps are, however, not a part of the characterization of the recombinant polyclonal protein since they do not necessarily provide any separation of the different homologous proteins in the composition. Preferably, the sample subjected to the characterization process of the present invention has been subjected to at least one purification step.

The different homologous proteins constituting the polyclonal protein can be quantitated on samples obtained from a single polyclonal cell culture at different time points during the cultivation, thereby monitoring the relative proportions of the individual polyclonal protein members throughout the production run to assess its compositional variability during cultivation. Alternatively, different homologous proteins constituting the polyclonal protein can be quantitated on samples obtained from different manufacturing runs, thereby monitoring the compositional variability in different batches to assess batch-to-batch consistency.

A sample to be characterized by the methods of the present invention comprises in one embodiment a defined subset of different homologous proteins having different variable region proteins, in particular different recombinant proteins. Typically, the individual members of a polyclonal protein have been defined by a common feature such as the shared binding activity towards a desired target, e.g. in the case of antibodies. Typically, a polyclonal protein composition to be analyzed by the characterization platform of the present invention will comprise at least 2, 3, 4, 5, 10 or 20 distinct variant members (different homologous proteins). The polyclonal protein composition will thus typically comprise (at least) 2 different homologous proteins, such as (at least) 3, (at least) 4, (at least) 5, (at least) 6, (at least) 7, (at least) 8, (at least) 9, (at least) 10, (at least) 11, (at least) 12, (at least) 13, (at least) 14, (at least) 15, (at least) 16, (at least) 17, (at least) 18, (at least) 19, (at least) 20, (at least) 21, (at least) 22, (at least) 23, (at least) 24 or (at least) 25 different homologous proteins, such as between 2 and 30 different homologous proteins, for example between 2 and 5, between 6 and 10, between 11 and 15, between 16 and 20, between 21 and 25 or between 26 and 30 different homologous proteins. In some cases, the polyclonal protein composition may comprise a greater number of distinct variant members, such as at least 50 or 100 different homologous proteins. In one embodiment, no single variant member constitutes more than 75% of the total number of individual members in the polyclonal protein composition, such as no more that 50%, or for example no more than 25% or such as no more than 10%, or for example no more than 1% of the total number of individual members in the final polyclonal composition.

In a preferred embodiment of the present invention, the sample comprising the different homologous proteins having different variable regions is a polyclonal antibody. The polyclonal antibody can be composed of one or more different antibody subclasses or isotypes, such as the human isotypes IgG1, IgG2, IgG3, IgG4, IgA1, and IgA2, or the murine isotypes IgG1, IgG2a, IgG2b, IgG3, and IgA.

The present invention further relates to a method for characterization of a population of different antibody species in a recombinant polyclonal antibody composition. The method is useful for quantitative analysis and can be used, for example, to analyse batch-to-batch consistency as well as to assess the compositional stability during a manufacturing run and to determine whether a given batch fulfils certain predefined release specifications. In another embodiment the present invention can be used for selection of clones for a polyclonal cell bank—i.e. selection of clones that results in the desired antibody composition during production.

The invention also provides for a method for detecting variance between a population of antibodies in recombinant polyclonal antibody compositions.

In one embodiment, the recombinant polyclonal antibody compositions are obtained from a single polyclonal cell culture at different time points during the cultivation. In a second embodiment, the recombinant polyclonal antibody compositions are obtained from different polyclonal cell cultures at a particular time point. In a third embodiment, the variance is detected by comparing the relative proportion of at least three, such as at least 5 or at least 10 antibodies present in the recombinant polyclonal antibody compositions.

The method according to the present invention can also be implemented for simultaneous analysis of the in vivo clearance of individual antibodies constituting a recombinant polyclonal antibody composition/product in serum from an individual such as a human being for e.g. pharmacokinetic studies. In one embodiment at least two recombinant proteins such as at least two recombinant polyclonal antibodies have been administered to said individual.

The invention also relates to characterization of polyclonality in a drug substance/product. For use in process development and drug substance characterization the method according to the present invention provides determination of relative and absolute concentration of antibodies that can be performed at a reasonable throughput such as high throughput. In another embodiment the invention relates to quantitation of one or more recombinant antibodies in in-process samples.

In order to identify and quantify the individual antibodies of a recombinant polyclonal composition/product there must be unique signature peptides from variable region in all antibodies which will be released by the same protease or combination of proteases.

In one embodiment the recombinant proteins to be analyzed comprise one or more recombinant B-cell receptors.

In another embodiment the recombinant proteins to be analyzed comprise one or more recombinant T-cell receptors.

The sample to be analysed by the method disclosed in the present invention can be a sample such as a serum or plasma derived from an individual. Said individual can be a human being or an animal including laboratory/test animal. The animal can be a rabbit, hamster, mouse, rodent, rat, monkey, cow, pig, horse, donkey, chicken, fish or any other animal used for experimental testing.

The sample to be analysed can be obtained from one or more of the individuals selected from the group consisting of a human being, a man, a woman, a post-menopausal women, a pregnant woman, a lactating woman, an infant, a child, or an adult. The individual such as a human being can be of any age such as from newborn to 120 years old, for example from 0 to 6 months, such as from 6 to 12 months, for example from 1 to 5 years, such as from 5 to 10 years, for example from 10 to 15 years, such as from 15 to 20 years, for example from 20 to 25 years, such as from 25 to 30 years, for example from 30 to 35 years, such as from 35 to 40 years, for example from 40 to 45 years, such as from 45 to 50 years, for example from 50 to 60 years, such as from 60 to 70 years, for example from 70 to 80 years, such as from 80 to 90 years, for example from 90 to 100 years, such as from 100 to 110 years, for example from 110 to 120 years. The individual can be of any race such as a Caucasian, a black person, an East Asian person, a person of Mongoloid race, a person of Ethiopian race, a person of Negroid race, a person of American Indian race, or a person of Malayan race.

Said human being or animal can be healthy or have one or more diseases. Said human being or animal can be diagnosed and/or treated for one or more diseases. In one embodiment said individual is genetically disposed for one or more diseases.

Method for Manufacturing Recombinant Polyclonal Antibodies

The present invention further relates to a method for manufacturing recombinant polyclonal antibodies comprising a step wherein the present method for quantitation of recombinant proteins in a sample is used. Accordingly, polyclonal antibodies which can be quantitated by said method can be selected from a pool of polyclonal antibodies.

### EXAMPLES

### Example 1

This example describes multiplex quantification of a recombinant polyclonal antibody composition consisting of a 1:1 mixture of the two antibodies A992 and A1024 against the epidermal growth factor receptor (EGFR) (WO 2008/104183). Pre-clinical pharmacokinetic (PK) measurements in a Cynomolgus monkey were shown, where the individual antibodies A992 and A1024 have been measured in plasma following administration of the drug lead.

A PK profile was measured in plasma on samples collected after administration of one dose of the drug lead (18 mg) i.e. 9 mg A992 and 9 mg A1024 to a single Cynomolgus Monkey. These PK samples were analyzed together with samples containing a pool of blank Cynomolgus monkey plasma from three subjects spiked with the drug lead at different concentrations. The analysis consists of two parts:
Up-concentration of the A992 and A1024 by Protein A affinity chromatography.
Liquid chromatography-mass spectrometry (LC-MS) using AQUA peptides (Sigma).

Up-concentration by Protein A Affinity Chromatography

Samples containing 25 μl pooled blank Cynomolgus monkey plasma from three subjects were spiked with the drug lead at the following concentrations: 0, 5, 10, 20, 50, 100, 150 and 200 μg/ml. PBS pH 7.2 (Gibco) was added to a total volume of 100 μl. PK samples were prepared by adding 25 μl plasma to PBS pH 7.2 (Gibco) for a total volume of 100 μl. The samples were loaded on a 96 well Protein A HP MultiTrap plate (GE Healthcare). In all steps the liquid in the wells was removed by evacuation using a Univac manifold (Whatman) except in step 6 where an Eppendorf centrifuge model number 5804R was used. The following procedure was applied:

Preparation of citrate phosphate buffer:

Citric acid 0.1M:

19.21 g Citric Acid (Sigma) dissolved in water to 1000 ml, prepared in a 1 L volumetric flask.

Na₂HPO₄, 200 mM :

53.61 g Na₂HPO₄.7*H2O (Merck) dissolved in water to 1000 ml, prepared in a 1 L volumetric flask.

Citrate Phosphate pH 6.5 (Stock A):

136 ml 0.1M Citric Acid and 364 ml 0.2 M Na₂HPO₄ (Merck) adds water to 900 ml. Add water to 1000 ml.

Citrate Phosphate pH 3.5 (Stock B):

359 ml 0.1 M Citric Acid +141 ml 0.2 M Na₂HPO₄ add water to 900 ml. Fill water to 1000 ml.

Citrate Phosphate pH 5.25:

567 ml Citrate Phosphate Stock A +433 ml Citrate Phosphate Stock B.

Protein A Affinity Purification Procedure:

Step 1: Preparation of Protein A HP MultiTrap plate

Suspend the storage solution by shaking the plate up and down, remove seals and evacuate the storage solution according to manufactures procedure.

Step 2: Equilibration

Add 300 μl PBS pH 7.2 to each well.

Step 3: Binding of Drug Lead

Add 100 μl spiked sample or PK sample to each well and incubate the plate in an Eppendorf thermomixer comfort at room temperature for 4 min. at 800 rpm.

Step 4: Wash 1

a) Add 250 μl PBS pH 7.2 to each well and evacuate.

b) Add 250 μl PBS pH 7.2 to each well and evacuate.

Step 5: Wash 2

a) Add 250 μl citrate phosphate wash buffer pH 5.25 to each well and evacuate.

b) Add 250 μl citrate phosphate wash buffer pH 5.25 to each well and evacuate.

Step 6: Elution of Drug Lead

Place the Protein A HP MultiTrap plate on a 96 well collection plate (GE Healthcare).

a) Add 200 μl citrate phosphate elution buffer pH 3.5 to each well and centrifuge at 70×g.

b) Add 200 μl citrate phosphate elution buffer pH 3.5 to each well and centrifuge at 70×g.

Preparation of Samples for LC-MS

Following up-concentration by protein A affinity chromatography the samples containing endogenous Ig and the drug lead were prepared for LC-MS analysis. During this step the AQUA peptides were added to the samples. AQUA peptides are synthetic peptides that are identical to the unique signature peptides from A992 and A1024, but which contain one stable isotope labelled amino acid allowing these peptides to be distinguished using MS analysis from the signature peptides. The labelled amino acid contains 98 atom % ¹³C and ¹⁵N and the mass was thus increased compared to native signature peptides of A992 and A1024. The AQUA peptides selected for absolute quantitation were reported in Table 1.

TABLE 1
Signature peptides used for absolute quantitation. Mass to charge (m/z)
values were shown for the single (MH⁺), double (MH²⁺)
and triple (MH³⁺) charged peptides that were formed
when the peptides were ionized during electrospray ionization (ESI).

| Anti- | | m/z | m/z | m/z | | |
|---|---|---|---|---|---|---|
| body | Residue | (MH⁺) | (MH²⁺) | (MH³⁺) | pI | Sequence |
| A992 | 1-19 of | 2022.10 | 1011.55 | 674.705 | 7.03 | EVQLQQPGSEL |
| | heavy | | | | | VRPGASVK |
| | chain | | | | | |
| A1024 | 39-57 | 2081.05 | 1041.03 | 694.355 | 6.85 | QRPGQGLEWI |
| | of | | | | | GEINPSSGR |
| | heavy | | | | | |
| | chain | | | | | |

TABLE 2
AQUA ® peptides used for absolute quantitation. Mass to charge (m/z)
values were shown for the single (MH⁺), double (MH²⁺) and triple (MH³⁺) charged peptides
that were formed when the peptides were ionized during ESI. The lysine (K) and
arginine (R) in bold and underlined were the labelled amino acids in the AQUA peptides.

| | | m/z | m/z | m/z | | |
|---|---|---|---|---|---|---|
| Anti-body | Residue | (MH⁺) | (MH²⁺) | (MH³⁺) | pl | Sequence |
| A992 | 1-19 of heavy chain | 2030.114 | 1015.561 | 677.377 | 7.03 | EVQLQQPGSELVRPGASVK |
| A1024 | 39-57 of heavy chain | 2091.058 | 1046.033 | 697.691 | 6.85 | QRPGQGLEWIGEINPSSGR |

The following procedure was applied for preparation of samples for LC-MS:

The immunoglobulins (Ig) eluted from protein A HP MultiTrap plate were precipitated using 800 μl ice cold acetone (Merck). The samples were subsequently dissolved in 9 μl 1% Rapigest SF Surfactant (Waters) and heated in an Eppendorf Thermomixer Comfort at 100° C. for 5 min. with mixing at 800 rpm. The samples were added 50 mM NH₄HCO₃, 1 mM CaCl₂ to a final volume of 90 μl and the samples were heated in an Eppendorf Thermomixer Comfort at 100° C. for 5 min. with mixing at 800 rpm. Subsequently, the samples were reduced using 0.1M dithiothreitol (DTT) (Sigma), alkylated using 0.25M iodoacetamide (Sigma), and digested with trypsin (Worthington) at 37° C. for 16 hours using an enzyme to Ig ratio of 1:20 (w/w).The digestion was quenched by addition of trifluoroacetic acid (TFA) (Fluka) to a final concentration of 1% (v/v) and samples were incubated at 37° C. for 30 min. 10 μl of a 1:1 mixture of A992 and A1024 AQUA (Sigma) peptides in 0.1% (v/v) formic acid (FA) (Fluka) with a concentration of 2 pmol total AQUA/μl was added, i.e. the total amount of each AQUA peptide in the sample was 10 pmol. The samples were centrifuged for 10 min. at 14100 rcf in an Eppendorf minispin plus centrifuge and transferred to HPLC vials (Dionex).

Quantitation by LC-MS

The peptides were separated by reversed-phase LC using a Zorbax 300SB-C18 column (2.1×150 mm ; Agilent) and a RSLC system Ultimate 3000 (Dionex). The solvents were solvent A: Water with 0.1% (v/v) FA (Fluka), solvent B: Acetonitrile with 0.1% (v/v) FA (Fluka) and a flowrate of 200 μl/min. The samples were loaded at 5% solvent B, and eluted using a gradient from 15% to 40% solvent B for 30 min. The column was washed in 80% solvent B for 20 min and the column was re-equilibrated at 5% solvent B for 14.7 min.

Mass Spectrometry

The peptides were analysed on a microQTOF instrument (Bruker). For the analysis of the samples acquisition was performed in the m/z range from 400 to 3000 with the parameters in Table 3.

TABLE 3
Parameters for MS method on a microQTOF instrument.
Ionization parameters:

| | |
|---|---|
| Ion polarity | positive |
| Capillary voltage | 4500 V |
| End plate offset | −500 V |
| Nebulizer gas | 1.2 bar |
| Dry gas heater | 200 °C. |
| Dry gas flow | 8.0 l/min |

Mass analyser parameters:

| | |
|---|---|
| Hexapole radio-frequency | 375 Vpp |

Detector parameters:

| | |
|---|---|
| Scan time | 1.00 sec |

In the beginning of each run a calibration segment was included where 20 μl of ESI tuning mix (Agilent) was injected via a divert valve. Extracted ion chromatograms (EIC) of m/z values for the MH³⁺ and MH²⁺ charge states of the signature and AQUA peptides were generated, and the extracted m/z width was set to 0.02. The ratio between signature peptide and AQUA peptide was determined from the area of the specific signature and AQUA peptide compounds detected in the EICs (Table 4).

TABLE 4
EICs used for determination of peak
area of signature and AQUA peptides.

| | |
|---|---|
| A992 | A1024 |

| m/z Signature | m/z AQUA | m/z Signature | m/z AQUA |
|---|---|---|---|
| peptide | peptide | peptide | peptide |
| 674.705 | 677.3766 | 694.355 | 697.691 |
| | | 694.690 | 698.026 |
| | | 1041.028 | 1046.033 |
| | | 1041.531 | 1046.535 |

The m/z values for A992 were the MH³⁺ charged ions. For A1024 the two first isotopes of both the MH³⁺ and MH²⁺ charged ions were used.

Results

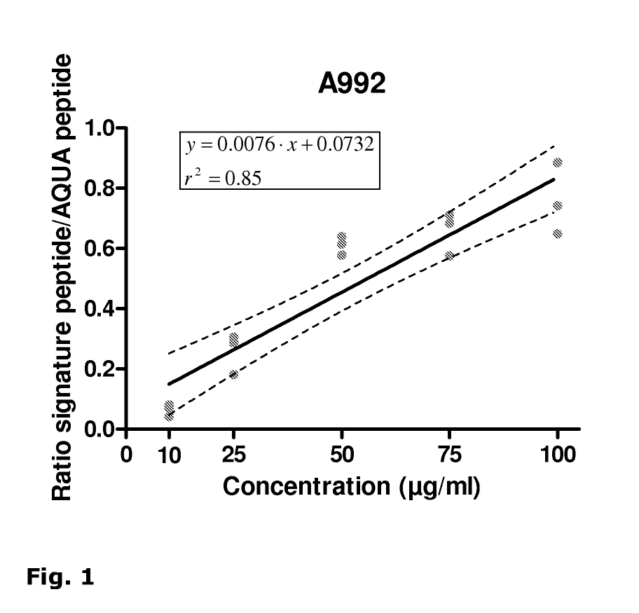

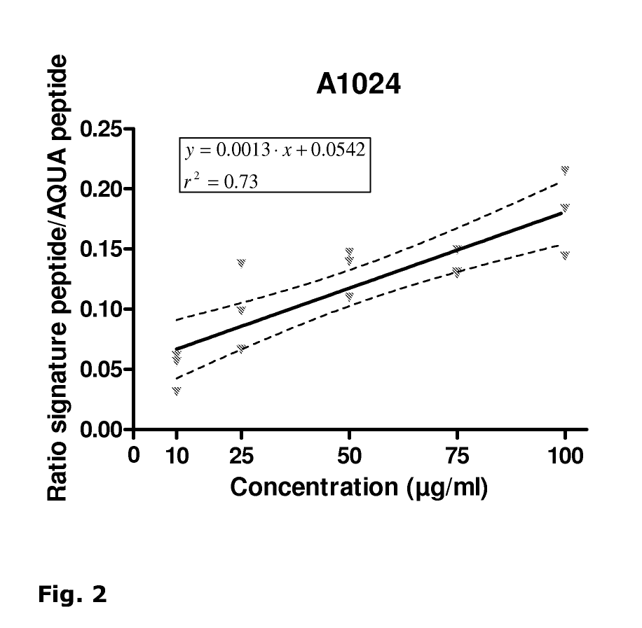

The ratio between the peak areas of signature peptides to AQUA peptides for A992 and A1024 in the EICs can be correlated to the concentration of the drug lead by standard curves. In this experiment the drug lead, consisting of both A1024 and A992, was spiked in a plasma pool from three Cynomolgus monkeys at eight concentrations: 0, 5, 10, 20, 50, 100, 150 and 200 μg/ml for generation of a standard curve. For each of the antibodies these concentrations correspond to 0, 2.5, 5, 10, 25, 50, 75 and 100 μg/ml (FIG. 1 and FIG. 2).

The standard curves showed that it was possible to correlate the ratio of A992 and A1024 signature peptide to AQUA peptides with the concentration of the drug lead spiked in Cynomolgus monkey plasma. The results furthermore demonstrate that the ratio of signature to AQUA peptide for A992 and A1024 can be determined in the range of 10 to 100 μg/ml of the individual antibodies. No peaks for the signature peptides of A992 or A1024 were detected for samples spiked with <10 μg/ml A992 or A1024.

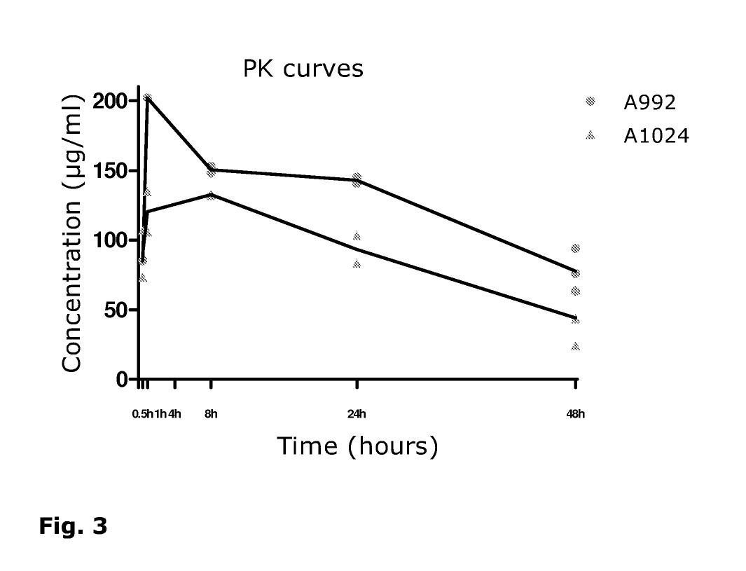

The standard curves in FIG. 1 and FIG. 2 were used to determine the concentration of A992 and A1024 in samples from a preclinical PK study of the drug lead in a Cynomolgus monkey. The ratio between the peak areas of the A992 and A1024 signature and AQUA peptides were determined at the sampling points at 0, 0.5, 1, 4, 8, 24, 48 hours and at days 9, 16, 23, 30, 37 and 44 following administration of 8 mg/kg of the drug lead. The pharmacokinetic curves for A992 and A1024 are shown in FIG. 3.

The concentration of A992 and A1024 was determined in the samples from the time points from 0.5 to 48 hours following administration of a single dose of 8 mg/kg drug lead. It can be observed that the two antibodies follow the same degration pattern.

### Example 2

This example describes multiplex quantification of a recombinant antibody composition consisting of a 1:1 mixture of the two antibodies A992 and A1024 against the epidermal growth factor receptor (EGFR) (WO 2008/104183). The antibodies were spiked in a donor serum pool and measured simultaneously. Two standard curves were generated, one for each antibody.

Samples

The two antibodies were spiked into serum at 100 μg/ml for each antibody. The sample was then diluted in serum to generate samples for standard curve. The serum used was a pool of 10 healthy donors. Table 5 shows the concentrations used in generation of the standard curves.

TABLE 5
The samples used for generation of the standard curves.

| | Concentration | Concentration |
|---|---|---|
| Level | [μg/ml] | pmol AB/33 μl serum |
| 8 | 100 | 44 |
| 7 | 50 | 22 |
| 6 | 25 | 11 |
| 5 | 6.25 | 2.75 |
| 4 | 1.6 | 0.7 |
| 3 | 0.8 | 0.35 |
| 2 | 0.4 | 0.16 |
| 1 | 0.2 | 0.08 |

The concentration indicates the concentration of each antibody in one sample/one well.

Sample Preparation

Total IgG was purified on 96-well Protein-A plate as described in Example 1, however, the plate was eluted in 200 μl 0.5M GndHCI/0.1 M Glycine pH 3.0. Three aliquots of 33 μl were analyzed for each standard curve point. The eluates was evaporated, and the reconstituted by addition of 50 μl 50 mM ammonium bicarbonate pr well. The protein was reduced by DTT (56° C., 1 h) and alkylated by IAA at room temperature for 1 h. The samples were transferred to a deep well plate and 15 pmol of each AQUA peptides were added pr well, and the samples were diluted with 50 mM ammonium bicarbonate.

The samples were diluted 1:1 in 4% phosphoric acid and purified on a Waters Oasis MCX ion exchange plate

The plate was eluted using 30 μl 30% NH₄OH in ACN/MeOH/well.

The plate was evaporated and 30 μl of 0.1% formic acid was added

LC-MS Set-up

The antibody concentrations in the samples were quantified using LC-MS and multi reaction monitoring of selected peptides from the CDR regions of the two antibodies. The samples were analyzed using the following:
Mass Spectrometer: Agilent 6400 Triple Quad LC/MS (QQQ)
HPLC: Agilent 1200 Series
Column: Waters Acquity UPLC BEH300 C18 1.7 μm, 2.1×50 mm column
Flowrate: 300 μl/min
Solvent A: 0.1% formic acid
Solvent B: 99.9% ACN, 0.1% formic acid
Injection volume: 30 μl
MS1: Unit
MS2: Widest

30 μl was injected into the LC-MS system for each sample and the gradient shown in Table 6 was used.

TABLE 6
Gradient used for elution of peptides into the MS:

| Time | |
|---|---|
| [min] | B % |
| 0 | 5 |
| 0.5 | 5 |
| 8 | 20 |
| 8.01 | 100 |
| 10 | 100 |
| 10.01 | 5 |
| 12 | 5 |

For quantification two peptides were selected and ordered as AQUA™ peptides, i.e. containing a heavy isotope labeled amino acid. For this experiment two peptides were selected:

| | | | | ACN |
|---|---|---|---|---|
| Peak | Name | Sequence | pl | Elution % |
| 4 | 1024HC8 | ATLTVDK | 6.99 | 22.5 |
| 5 | 992HC1 | EVQLQQPGSELVRPGASVK | 7.03 | 32 |

Results

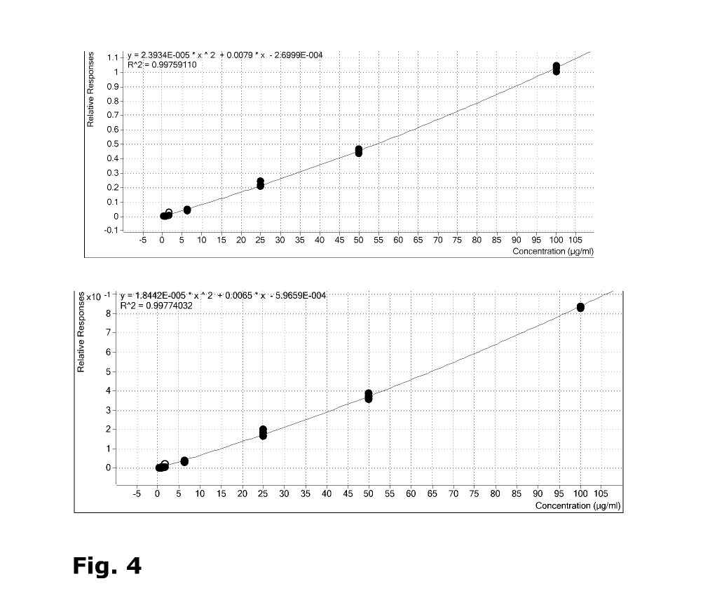

Two standard curves were generated one for each antibody, shown in FIG. 4. The measurements are in triplicate and demonstrate god reproducibility and standard curves fitted to a non-linear fit. The range of both curves are 0.2 μg/ml-100 μg/ml for each antibody. The two antibodies are measured simultaneously.

Abbreviations

| | |
|---|---|
| ACN | Acetonitrile |
| DTT | Dithiothreitol |
| EGFr | Epidermal growth factor receptor |
| EIC | Extracted ion chromatogram |
| ESI | Electrospray ionization |
| FA | Formic acid |
| Ig | Immunoglobulin |
| LC | Liquid chromatography |
| MS | Mass spectrometry |
| m/z | Mass/charge |
| pI | Isoelectric point |
| PBS | Phosphate buffered saline |
| PK | Pharmacokinetics |
| TFA | Trifluoroacetic acid |

### REFERENCES

[1] Anderson and Hunter, Mol Cell Proteomics. 2006 April;5(4):573-88.

[2] Dubois et al., Anal Chem. 2008 Mar. 1;80(5)1 737-45.

[3] Nicol et al. Mol Cell Proteomics. 2008 October;7(10):1974-82.

[4] Ackermann and Berna, Expert Rev Proteomics. 2007 April;4(2):175-86. Review.

[5] WO 2004/031730

[6] Ong and Mann, Nature Chemical Biology 1, 252-262 (2005).

[7] Yan and Chen HENRY STEWART PUBLICATIONS 1473-9550. BRIEFINGS IN FUNCTIONAL GENOMICS AND PROTEOMICS. VOL 4. NO 1. 1-12. MONTH 2005.

[8] Aebersold & Mann, Nature 2003, 422: 198-207

[9] Keshishian et al, Molecular & Cellular Proteomics 2007 December;6(12):2212-29.

1. A method for quantitation of one or more recombinant proteins in a sample comprising the steps of:
i) up-concentration of said one or more recombinant proteins by affinity purification to obtain a first fraction;
ii) digestion of said first fraction to release one or more specific signature peptides for each of said recombinant proteins into a second fraction;
iii) addition of one or more internal reference peptides for each of said signature peptides to said first fraction and/or said second fraction; and
iv) quantitation of said signature peptides by mass spectrometric analysis.

2. The method according to claim 1, wherein said method further comprises the steps of:
i) repetition of step i) to iv) in claim 1 with a corresponding protein preparation of known concentration spiked into the sample to obtain a protein standard curve; and ii) the quantitation of said signature peptides obtained in step iv) in claim 1 being compared to said protein standard curve obtained and quantitation of said one or more recombinant proteins in said sample being obtained.

3. The method according to claim 1, wherein said method further comprises a step of reduction and/or alkylation prior to the digestion in step ii) in claim 1.

4. The method according to claim 1, wherein said method further comprises a step of up-concentration of said signature peptides and said internal reference peptides using a resin with a chemistry able to fractionate the sample and thereby up-concentrate the peptides of interest.

5. The method according to claim 1, wherein said method further comprises a step of up-concentration of said signature peptides and said internal reference peptides using a resin coupled with anti-signature peptide antibodies followed by release of said signature peptides and said internal reference peptides to obtain a third fraction.

6. The method according to claim 1, wherein the affinity purification in step i) in claim 1 comprises binding to one or more immunoglobulin-binding proteins.

7. (canceled)

8. The method according to claim 6, wherein the immunoglobulin is a human, mouse, rabbit, goat, pie, cow, camel, dog cat, chicken, fish or monkey immunoglobulin, or a combination thereof.

9. The method according to claim 8, wherein the human immunoglobulin is human IgG1, human IgG2, human IgM, human IgA, or human or a combination thereof.

10. (canceled)

11. The method according to claim 8, wherein the mouse immunoglobulin is mouse IgG2a, mouse IgG2b, mouse IgG3, or mouse IgG1, or, a combination thereof.

12. The method according to claim 1, wherein the affinity purification in step i) comprises binding to protein A, protein G, protein A/G, or protein L, or a combination thereof.

13-15. (canceled)

16. The method according to claim 1, wherein the affinity purification in step i) comprises binding to an antibody against the constant part of a polyclonal antibody, to the Fc receptor, to Con A, or to a target for an antibody, or a combination thereof.

17-19. (canceled)

20. The method according to claim 1, wherein the digestion in step ii) is performed with trypsin, chymotrypsin. Asp-N, Glu-C, Lys-C, Lys-N, or Arg-C, or a combination thereof.

21-26. (canceled)

27. The method according to claim 1, wherein the digestion is performed essentially to completion.

28. The method according to claim 3, wherein the reduction is performed with dithiothreitol (DTT) or mercaptoethanol, or a combination thereof.

29. (canceled)

30. The method according to claim 3, wherein the alkylation is performed with 4-yinylpyridine, iodoacetamide, iodo acetic acid, iodoacetamide and iodo acetic acid, or a combination thereof.

31-32. (canceled)

33. The method according to claim 1, wherein the one or more internal reference peptides in step iii) are labeled with ¹³C, ¹⁵N, or ¹⁸O, or a combination thereof.

34-35. (canceled)

36. The method according to claim 1, wherein the one or more internal reference peptides in step iii) are generated a) by post-synthetic labeling, b) chemical synthesis, c) in live cells through metabolic incorporation, d) in vitro, e) by a method comprising deuterated acetate to label primary amino groups, f) by a method comprising n-terminal-specific reagents, g) by a method comprising permethyl esterification of peptides carboxyl groups, h) by a method comprising addition of twin ¹⁸O labels to the c-terminus of tryptic peptides during cleavage, i) by a method comprising N-terminal peptide labeling, j) by a method comprising N-terminal isotope-encoded tagging (NIT), k) by a method comprising C-terminal peptide labeling, l) by a method comprising labeling that are different from N-terminal and C-terminal peptide labeling, m) by a method comprising amino acid labeling, or n) by a method comprising amino acid labeling of one amino acid in each peptide, or a combination thereof.

37-38. (canceled)

39. The method according to claim 36, wherein the cells are part of a microorganism or are mammalian cells in culture.

40-51. (canceled)

52. The method according to claim 5, wherein the anti-signature peptide antibodies are polyclonal serum derived antibodies or monoclonal antibodies, or a combination thereof.

53. (canceled)

54. The method according to claim 1, wherein the internal reference peptide has a sequence identical to a sequence within a recombinant polyclonal antibody, a TcR, or a combination of a recombinant polyclonal antibody and a TcR.

55. The method according to claim 54, wherein the sequence within the recombinant polyclonal antibody is a) within the constant region of said recombinant polyclonal antibody, b) within the variable region of said recombinant polyclonal antibody, c) within the light chain of said recombinant polyclonal antibody, d) within the heavy chain of said recombinant polyclonal antibody, e) within the frameworks of said recombinant polyclonal antibody, f) within the hyper-variable domains of said recombinant polyclonal antibody, g) within the complementarity determining regions (CDR) of said recombinant polyclonal antibody, h) within a CDR1 of said recombinant polyclonal antibody, i) within a CDR2 of said recombinant polyclonal antibody, or j) within a CDR3 of said recombinant polyclonal antibody, or a combination thereof.

56-64. (canceled)

65. The method according to claim 4, wherein the signature peptides are upconcentrated using an ion exchange based separation, a reversed phased based separation, a hydrophilic interaction based separation, a hydrophobic interaction based separation, or a size exclusion based separation, or a combination thereof.

66-69. (canceled)

70. The method according to claim 5, wherein the anti-signature peptide antibodies are raised in rabbit, chicken, goat, or sheep, or a combination thereof.

71-73. (canceled)

74. The method according to claim 5, wherein the method is performed in a batch format, in a 96 well format, as part of a multidimensional liquid-chromatographic electrospray ionization-mass spectrometry (LC-MS) system, or offline, or a combination thereof.

75-77. (canceled)

78. The method according to claim 5, wherein the method comprises elution of said signature and reference peptides directly into the mass spectrometric ion source or the electrospray ionization (ESI) source.

79. (canceled)

80. The method according to claim 1, wherein the mass spectrometric analysis comprises a) ionization by ESI, b) ionization by matrix-assisted laser desorption/ionization (MALDI), c) LC-MS analysis comprising two or more dimensions of chromatographic fractionation, d) LC-MS analysis comprising multidimensional chromatography, e) LC-MS analysis comprising a single dimension of LC separation, f) LC-MS analysis comprising two or more dimensions of LC separation, g) fourier-transform ion cyclotron resonance (FTICR), h) Q-TOF or triple quadrupole based methods, i) LC-MS/MS, j) LC-ESI-MS/MS, k) LC-MALDI-MS/MS, l) multiple reaction monitoring (MRM) based methods, m) extracted ionchromatoerams, n) ion trap based methods, o) an ESI-triple quadrupole based method, p) Orbitrap based methods, q) ESI-TOF based methods, or r) ESI-O-TOF based methods, or a combination thereof.

81-96. (canceled)

97. The method according to claim 1, wherein the one or more recombinant proteins comprise two or more recombinant or chimeric polyclonal antibodies, or a combination thereof.

98. (canceled)

99. The method according to claim 97, wherein the two or more chimeric polyclonal antibodies comprises a human part and a mouse part.

100. The method according to claim 99, wherein the human part is the constant region of the polyclonal antibody or the variable region of the polyclonal antibody.

101. (canceled)

102. The method according to claim 99, wherein the mouse part is the constant region of the polyclonal antibody or the variable region of the polyclonal antibody.

103. (canceled)

104. The method according to claim 1, wherein the one or more recombinant proteins are in a sample comprising a background of other homologous proteins.

105. The method according to claim 1, wherein the sample is a serum sample, a plasma sample, a cell culture supernatant, or a bioreactor supernatant.

106-108. (canceled)

109. The method according to claim 1, wherein the one or more recombinant proteins comprises a recombinant polyclonal antibody used for treatment and/or prophylaxis of two or more infectious disease(s), two or more bacterial infection(s), two or more viral infection(s), or two or more cancer form(s), or a combination thereof.

110-112. (canceled)

113. The method according to claim 1, wherein the one or more recombinant proteins comprises a recombinant polyclonal antibody consisting of different recombinant polyclonal antibodies or anti-Rhesus D (RhD) antibodies.

114. (canceled)

115. The method according to claim 1, wherein the one or more recombinant proteins comprises a recombinant polyclonal anti-vaccinia virus antibody to replace existing anti-vaccinia hyperimmune immunoglobulins (VIG).

116. The method according to claim 1, wherein the one or more recombinant proteins comprises a recombinant polyclonal antibody targeting anti-respiratory syncytial virus (RSV), a human cancer antigen, a human EGFR, a bacterial pathogen, a viral pathogen, or an infectious disease target, or a combination thereof.

117-121. (canceled)

122. The method according to claim 1, wherein the one or more recombinant proteins comprises one or more recombinant B-cell receptors or T-cell receptors, or a combination thereof.

123-124. (canceled)

125. The method according to claim 1, wherein the method is used for determination of in vivo clearance of individual antibodies constituting a recombinant polyclonal antibody composition in a serum sample from an individual.

126. The method according to claim 1, wherein the method is used for pharmacokinetic studies of an individual.

127. The method according to claim 125, wherein the individual is a human being, a rodent, or a monkey.

128. The method according to claim 126, wherein the individual is a human being, a rodent, or a monkey.

129. (canceled)

130. The method according to claim 1, wherein the method is used for characterization of polyclonality in a drug substance, a drug product, or both.

131. (canceled)

132. The method according to claim 1, wherein the method is used for quantitation of one or more recombinant antibodies in in-process samples.

133. The method according to claim 1, wherein the method is used in connection with manufacturing of recombinant polyclonal antibodies, recombinant polyclonal antibodies upstream or downstream of production of a drug substance, or recombinant polyclonal antibodies upstream or downstream of production of a drug product, or a combination thereof.

134-135. (canceled)

136. The method according to claim 1, wherein the method is used for selection of clones for a polyclonal cell bank.

137. The method according to claim 1, wherein the number of recombinant proteins to be quantified are two or more.
